(19) United States
(12) Patent Application Publication
(10) Pub. No.: US 2014/0215432 A1
(43) Pub. Date: Jul. 31, 2014

(54) CODE GENERATING SYSTEM AND METHOD

(71) Applicant: GENERALPLUS TECHNOLOGY INC., HSINCHU CITY (TW)

(72) Inventor: YEN TSUN HUANG, TAOYUAN COUNTY (TW)

(73) Assignee: GENERALPLUS TECHNOLOGY INC., HSINCHU CITY (TW)

(21) Appl. No.: 14/160,047

(22) Filed: Jan. 21, 2014

(30) Foreign Application Priority Data
Jan. 25, 2013 (TW) 102102774

(51) Int. Cl. G06F 9/44

(52) U.S. Cl. CPC G06F 8/30
USPC 717/106

(57) ABSTRACT

A code generating system includes a code converting module and a linker. The code converting module is configured to generate a plurality of candidate instructions, in response to a source code. The candidate instructions are then saved in an object file. The linker comprises a selecting unit which is configured to select at least one instruction, in response to a sub-hardware condition of a hardware condition, from the plurality of candidate instructions. Moreover, the linker is configured to link the selected at least one instruction to generate a final code.

### TECHNICAL FIELD

The present invention is generally related to code generation and, more particularly, to a code generation system and method for generating instructions and a final code according to hardware conditions.

### BACKGROUND

FIG. 1 is a flow diagram illustrating a conventional method of code generation. Referring to FIG. 1, in the conventional method of code generation, in operation S101, a source code is received. The source code is associated with a hardware condition. Next, an object file is generated in operation S103 by assembling the source code in a computer. The object file includes only an instruction set. In operation S105, a final code is generated in response to the object file. However, the conventional method of code generation may not respond in real time to another hardware condition in selecting suitable instructions.

### SUMMARY

In accordance with embodiments of the present invention, a code generating system comprises a code converting module and a linker.

The code converting module is configured to generate a plurality of candidate instructions, in response to a source code, and the candidate instructions are saved in an object file.

The linker comprises a selecting unit which is configured to select at least one instruction, in response to a sub-hardware condition of a hardware condition, from the plurality of candidate instructions. Moreover, the linker is configured to link the selected at least one instruction to generate a final code.

In accordance with an embodiment of the present invention, the object file includes a hardware condition code indicating the hardware condition.

In accordance with another embodiment of the present invention, a candidate instruction includes at least one parameter indicating the sub-hardware condition of the hardware condition.

In accordance with yet another embodiment of the present invention, the sub-hardware condition includes a memory address.

In accordance with still another embodiment of the present invention, the sub-hardware condition includes a bit value of a register.

In accordance with yet still another embodiment of the present invention, the sub-hardware condition includes a bit size of the register.

In accordance with an embodiment of the present invention, the code converting module includes an assembler.

In accordance with another embodiment of the present invention, the selecting unit includes a multiplexer.

In accordance with still another embodiment of the present invention, the final code includes an execution file.

In accordance with some embodiments of the present invention, a method for generating a code using a computer comprises generating a plurality of candidate instructions in response to a source code and saving the candidate instructions in an object file, selecting at least one candidate instruction, in response to a sub-hardware condition of a hardware condition, from the plurality of candidate instructions, and linking the selected at least one instruction to generate a final code.

Moreover, the source code is associated with the object file.

In accordance with an embodiment of the present invention, the object file includes a hardware condition code indicating the hardware condition.

In accordance with another embodiment of the present invention, each of the candidate instructions includes at least one parameter indicating the sub-hardware condition of the hardware condition.

In accordance with yet another embodiment of the present invention, the sub-hardware condition includes a memory address.

In accordance with still another embodiment of the present invention, the sub-hardware condition includes a bit value of a register.

In accordance with yet still another embodiment of the present invention, the sub-hardware condition includes a bit size of the register.

In accordance with a further embodiment of the present invention, the final code includes an execution file.

In accordance with a still further embodiment of the present invention, the step of generating a plurality of candidate instructions in response to a source code further comprises receiving the source code.

In accordance with an embodiment of the present invention, the step of selecting at least one instruction further comprises calling an object file.

### BRIEF DESCRIPTION OF THE DRAWINGS

Details of one or more embodiments of the disclosure are set forth in the accompanying drawings and the description below. Other features and advantages of the disclosure will be apparent from the description, drawings and claims.

FIG. 1 is a flow diagram illustrating a conventional method of code generation.

FIG. 2 is a schematic diagram of a code generating system in accordance with an embodiment of the present invention.

FIG. 3 is a schematic diagram of a code generating system in accordance with another embodiment of the present invention.

FIG. 4 is a flow diagram of a method for a code generating system in accordance with an embodiment of the present invention.

### DETAIL DESCRIPTION

Embodiments or examples of the disclosure illustrated in the drawings are now described in specific languages. It will nevertheless be understood that no limitation of the scope of the disclosure is thereby intended. Any alterations and modifications in the described embodiments, or any further applications of principles described in this document are contemplated as would normally occur to one of ordinary skill in the art to which the disclosure relates. Reference numerals may be repeated throughout the embodiments, but this does not necessarily require that feature(s) of one embodiment apply to another embodiment, even if they share the same reference numeral.

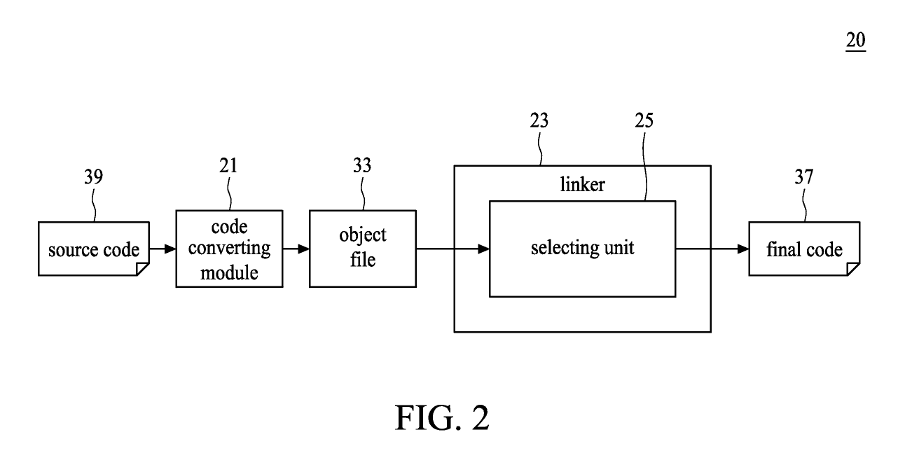

FIG. 2 is a schematic diagram of a code generating system 20 in accordance with an embodiment of the present invention. Referring to FIG. 2, the code generating system 20 comprises a code converting module 21 and a linker 23. The code converting module 21 includes an assembler and is configured to generate a plurality of candidate instructions in response to a source code 39 associated with a hardware condition. The candidate instructions generated by the code converting module 21 are saved in an object file 33. The candidate instructions, in some embodiments, may each include a memory address, a bit value of a register and a bit size of the register.

The linker 23 includes a selecting unit 25, for example, a multiplexer, which is configured to select at least one instruction, in response to a sub-hardware condition of the hardware condition, from the candidate instructions. Moreover, the sub-hardware condition is associated with one of the candidate instructions. The linker 23 is configured to link the selected at least one instruction to generate a final code, such as an execution file.

Moreover, the object file 33 includes a hardware condition code associated with the hardware condition. In some embodiments, one of the candidate instructions includes at least one parameter indicating the sub-hardware condition of the hardware condition. The sub-hardware condition includes a memory address, a bit value of a register and a bit size of the register.

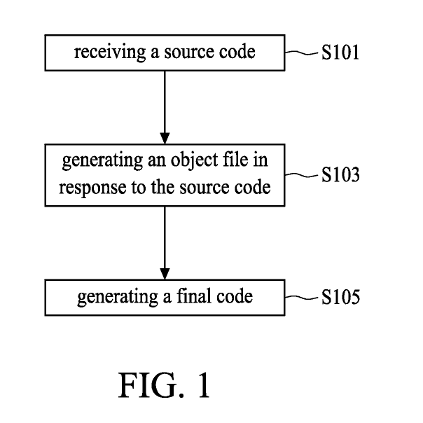

In some existing approaches, as the method illustrated in FIG. 1, a first object file is generated according to a first source code associated with a first hardware condition. When a second hardware condition appears, a second source code associated with the second hardware condition is coded. Then a second object file is generated by an assembler. Subsequently, a final code is generated by a linker. By comparison, in the present disclosure, in response to a second hardware condition, the selecting unit 25 of the linker 23 selects instructions associated with the second hardware condition from candidate instructions in the object file 33, and links the selected instructions to generate a final code. In this manner, no second source code is coded.

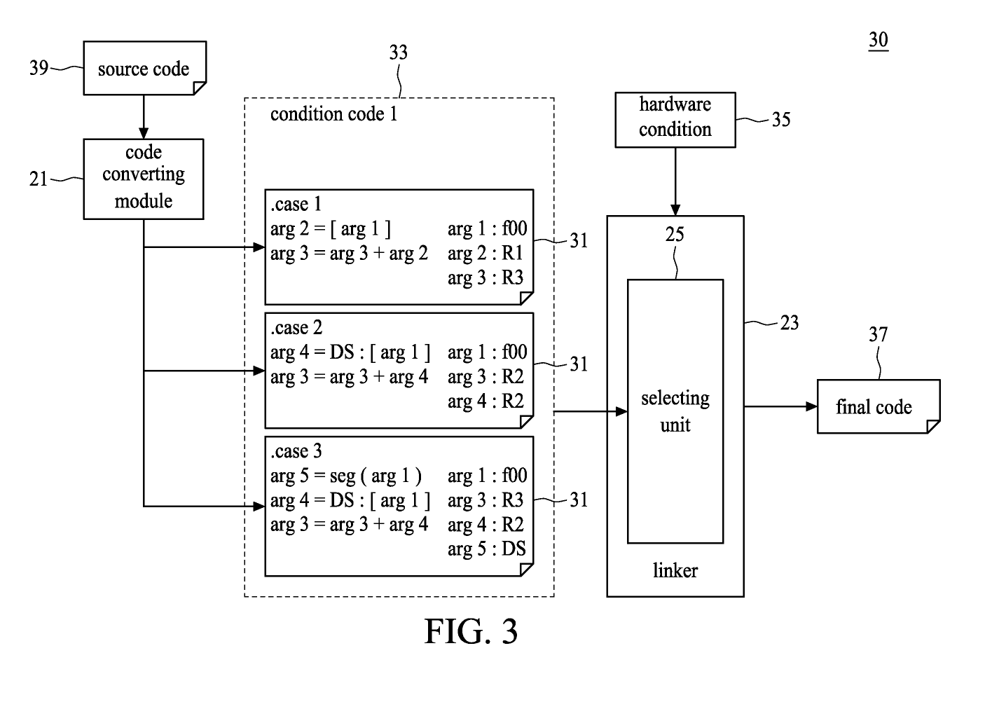

Operation of a code generating system of the present invention will be discussed in more detail below with reference to FIG. 3.

FIG. 3 is a schematic diagram of a code generating system 30 in accordance with another embodiment of the present invention. Referring to FIG. 3, the code converting module 21 generates a plurality of candidate instructions 31 in response to source code 39. The candidate instructions 31 are then saved in object file 33. Moreover, each of the candidate instructions 31 comprises at least one parameter such as arg1, arg2, arg3, arg4 or arg5.

When a hardware condition 35 is received by the linker 23, the object file 33, having a hardware condition code associated with the hardware condition, is called by the linker 23. At least one of the candidate instructions 31 is selected, according to a sub-hardware condition of the second hardware condition 35, by the selecting unit 25. The selected at least one instruction is then linked by the linker 23 to generate a final code 37.

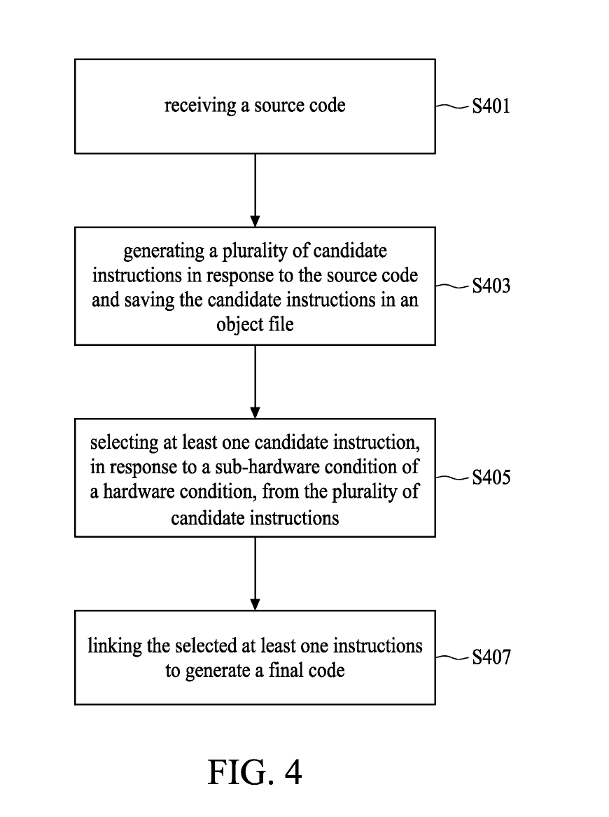

FIG. 4 is a flow diagram of a method for a code generating system in accordance with an embodiment of the present invention. The code generating system includes a code converting module and a linker as those described and illustrated with reference to FIG. 3. Referring to FIG. 4, in operation S401, a source code is received by the code converting module. In operation S403, a plurality of candidate instructions are generated in response the source code, and the candidate instructions are saved in an object file.

In operation S405, when a hardware condition is received by the linker, the object file, having a hardware condition code associated with the hardware condition, is called by the linker. Subsequently, at least one candidate instruction is selected, in response to a sub-hardware condition of the hardware condition, from the candidate instructions by a selecting unit in the linker. In operation S407, the selected at least one instruction is then linked by the linker to generate a final code.

A number of embodiments of the disclosure have been described. It will nevertheless be understood that various modifications may be made without departing from the spirit and scope of the disclosure. Embodiments of the disclosure are applicable in various design choices.

The above description includes exemplary operations, but these operations are not necessarily required to be performed in the order shown. Operations may be added, replaced, changed order, and/or eliminated as appropriate, in accordance with the spirit and scope of the disclosure. Accordingly, the scope of the disclosure should be determined with reference to the following claims, along with the full scope of equivalences to which such claims are entitled.

What is claimed is:

1. A code generating system, comprising:
a code converting module configured to generate a plurality of candidate instructions in response to a source code, the candidate instructions being saved in an object file; and
a linker, comprising:
a selecting unit configured to select at least one instruction, in response to a sub-hardware condition of a hardware condition, from the plurality of candidate instructions;
wherein the linker is configured to link the selected at least one instruction to generate a final code.

2. The code generating system of claim 1, wherein the object file includes a hardware condition code indicating the hardware condition.

3. The code generating system of claim 1, wherein one of the candidate instructions includes at least one parameter indicating the sub-hardware condition of the hardware condition.

4. The code generating system of claim 3, wherein the sub-hardware condition includes a memory address.

5. The code generating system of claim 3, wherein the sub-hardware condition includes a bit value of a register.

6. The code generating system of claim 3, wherein the sub-hardware condition includes a bit size of the register.

7. The code generating system of claim 1, wherein the code converting module includes an assembler.

8. The code generating system of claim 1, wherein the selecting unit includes a multiplexer.

9. The code generating system of claim 1, wherein the final code includes an execution file.

10. A method for generating a code by a computer, the method comprising:
generating a plurality of candidate instructions in response to a source code and saving the candidate instructions in an object file, wherein the source code is associated with the object file;
selecting at least one candidate instruction, in response to a sub-hardware condition of a hardware condition, from the plurality of candidate instructions; and
linking the selected at least one instruction to generate a final code.

11. The method of claim 10, wherein the object file includes a hardware condition code indicating the hardware condition.

12. The method of claim 10, wherein a candidate instruction includes at least one parameter indicating the sub-hardware condition of the hardware condition.

13. The method of claim 12, wherein the sub-hardware condition includes a memory address.

14. The method of claim 12, wherein the sub-hardware condition includes a bit value of a register.

15. The method of claim 12, wherein the sub-hardware condition includes a bit size of the register.

16. The method of claim 10, wherein the final code includes an execution file.

17. The method of claim 10, wherein the step of generating a plurality of candidate instructions in response to a source code further comprises receiving the source code.

18. The method of claim 10, wherein the step of selecting at least one instruction further comprises calling the object file.
